(19) United States
(12) Patent Application Publication
(10) Pub. No.: US 2025/0239684 A1
(43) Pub. Date: Jul. 24, 2025

(54) RECHARGEABLE ENERGY STORAGE SYSTEM (RESS) INCLUDING A HEAT EXCHANGE MEMBER HAVING A COOLING SYSTEM INCLUDING AN INFLATABLE BLADDER

(71) Applicant: GM Global Technology Operations LLC, Detroit, MI (US)

(72) Inventors: William Yu Chen, Troy, MI (US); Xianfeng Yan, Clawson, MI (US); Qaiser Khan, Novi, MI (US); Andrew P. Oury, Troy, MI (US)

(21) Appl. No.: 18/419,644

(22) Filed: Jan. 23, 2024

(51) Int. Cl. H01M 10/6556; H01M 10/613; H01M 10/625; H01M 10/653; H01M 10/6554; H01M 50/249; H01M 50/291; H01M 50/367

(52) U.S. Cl. CPC H01M 10/6556; H01M 10/613; H01M 10/625; H01M 10/653; H01M 10/6554; H01M 50/249; H01M 50/291; H01M 50/367; H01M 2220/20

(57) ABSTRACT

A battery assembly includes a housing having a battery cell support surface and a plurality of side walls that collectively define an interior zone. A plurality of battery cells is arranged in the interior zone. A heat exchange member is mounted to the housing, the heat exchange member including a bottom plate. A cooling system is arranged in the heat exchange member. The cooling system includes an inflatable bladder arranged between the battery cell support surface and the bottom plate. The inflatable bladder is selectively inflated with a cooling fluid to be brought into contract with the battery cell support surface.

### INTRODUCTION

The subject disclosure relates to the art of electric vehicles and, more particularly, to an electric vehicle having a rechargeable energy storage system (RESS) including a heat exchange member plate having a cooling system including an inflatable bladder.

Many newer vehicles are being manufactured with electric propulsion systems. The electric propulsion system, be it a full electric system or a hybrid electric system, relies on an electric motor that is powered by energy stored in a rechargeable energy storage system (RESS) or battery assembly having a number of battery cells. While in operation, the battery cells generate heat. The heat detracts from battery efficiency. In order to remove heat produced by the battery, many vehicles include a cooling system that circulates a cooling fluid or coolant that is in thermal contact with the battery cells.

In some cases, the cooling system includes a plate arranged in a battery housing. Battery cells rest upon the plate. The coolant passes through conduits in the plate in a heat exchange relationship with the battery cells. The coolant absorbs heat from the battery cells and is then passed through a heat exchanger before being circulated back into the plate. Heat exchange is limited by the surface area of the conduits in contact with the battery cells or the battery cell support surface. Increasing the surface contact area will improve cooling. Accordingly, it is desirable to provide a system that increases surface area of contacting heat exchange surfaces in order to improve cooling and battery operation.

### SUMMARY

A battery assembly, in accordance with a non-limiting example, includes a housing having a battery cell support surface and a plurality of side walls that collectively define an interior zone. A plurality of battery cells is arranged in the interior zone. A heat exchange member is mounted to the housing, the heat exchange member including a bottom plate. A cooling system is arranged in the heat exchange member. The cooling system includes an inflatable bladder arranged between the battery cell support surface and the bottom plate. The inflatable bladder is selectively inflated with a cooling fluid to be brought into contract with the battery cell support surface.

In addition to one or more of the features described herein a plurality of channels extend between the battery cell support surface and the bottom plate, wherein the inflatable bladder comprises a plurality of inflatable bladders, each of the plurality of inflatable bladders being arranged in a corresponding one of the plurality of channels.

In addition to one or more of the features described herein a cooling fluid supply system including an inlet manifold having an inlet conduit is fluidically connected to each of the plurality of inflatable bladders and an outlet manifold having an outlet conduit fluidically connected to each of the plurality of inflatable bladders.

In addition to one or more of the features described herein the heat exchange member includes a first edge, a second edge opposite the first edge, a first side edge, and a second side edge opposite the first side edge, a first stiffening member extends along the first edge, and a second stiffening member extends along the second edge, the first stiffening member and the second stiffening member being joined to the battery cell support surface and the bottom plate.

In addition to one or more of the features described herein a plurality of stiffening elements extend between and connect to the first stiffening member and the second stiffening member, each of the plurality of channels being defined by adjacent ones of the plurality of stiffening elements.

In addition to one or more of the features described herein select ones of the plurality of stiffening elements include a first recess that is receptive of the inlet conduit and a second recess that is receptive of the outlet conduit.

In addition to one or more of the features described herein each of the plurality of stiffening elements includes a vent passage, the battery cell support surface including a plurality of vent gas passages that fluidically connect the interior zone and the vent passage.

In addition to one or more of the features described herein the battery cell support surface fluidically isolates the interior zone from the plurality of inflatable bladders.

In addition to one or more of the features described herein the bottom plate includes a non-planar surface having a plurality of projections, each of the plurality of projections extending towards corresponding ones of the plurality of channels.

In addition to one or more of the features described herein one of a thermal interface material (TIM) layer and an adhesive layer is arranged between the plurality of battery cells and the battery cell support surface.

A vehicle, in accordance with a non-limiting example, includes a body, a plurality of wheels supporting the body, an electric drive unit supported in the body, and a battery assembly operatively connected to the electric drive unit. The battery assembly includes a housing including a battery cell support surface and a plurality of side walls that collectively define an interior zone. A plurality of battery cells is arranged in the interior zone. A heat exchange member is mounted to the housing. The heat exchange member includes a bottom plate. A cooling system is arranged in the heat exchange member. The cooling system includes an inflatable bladder arranged between the battery cell support surface and the bottom plate. The inflatable bladder is selectively inflated with a cooling fluid to be brought into contract with the battery cell support surface.

In addition to one or more of the features described herein a plurality of channels extend between the battery cell support surface and the bottom plate, wherein the inflatable bladder comprises a plurality of inflatable bladders, each of the plurality of inflatable bladders being arranged in a corresponding one of the plurality of channels.

In addition to one or more of the features described herein a cooling fluid supply system including an inlet manifold having an inlet conduit is fluidically connected to each of the plurality of inflatable bladders and an outlet manifold having an outlet conduit fluidically connected to each of the plurality of inflatable bladders.

In addition to one or more of the features described herein the heat exchange member includes a first edge, a second edge opposite the first edge, a first side edge, and a second side edge opposite the first side edge, a first stiffening member extends along the first edge, and a second stiffening member extends along the second edge, the first stiffening member and the second stiffening member being joined to the battery cell support surface and the bottom plate.

In addition to one or more of the features described herein a plurality of stiffening elements extend between and connect to the first stiffening member and the second stiffening member, each of the plurality of channels being defined by adjacent ones of the plurality of stiffening elements.

In addition to one or more of the features described herein select ones of the plurality of stiffening elements include a first recess that is receptive of the inlet conduit and a second recess that is receptive of the outlet conduit.

In addition to one or more of the features described herein each of the plurality of stiffening elements includes a vent passage, the battery cell support surface including a plurality of vent gas passages that fluidically connect the interior zone and the vent passage.

In addition to one or more of the features described herein the battery cell support surface fluidically isolates the interior zone from the plurality of inflatable bladders.

In addition to one or more of the features described herein the bottom plate include a non-planar surface having a plurality of projections, each of the plurality of projections extending towards corresponding ones of the plurality of channels.

In addition to one or more of the features described herein one of a thermal interface material (TIM) layer and an adhesive layer arranged between the plurality of battery cells and the battery cell support surface.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a rechargeable energy storage system (RESS) having a heat exchange member including a battery cell support surface and an inflatable cooling system, in accordance with a non-limiting example;

FIG. 2 is a partial perspective view of the RESS of FIG. 1, in accordance with a non-limiting example;

FIG. 3 is a cross-sectional view of the RESS taken along the line 3-3 in FIG. 2, in accordance with a non-limiting example;

FIG. 4 is a cross-sectional view of the RESS taken along the line 4-4 in FIG. 2, in accordance with a non-limiting example;

FIG. 5 is a top view of the RESS of FIG. 2 with the battery cell support surface removed, in accordance with a non-limiting example;

FIG. 6 is a cross-sectional view of the RESS of FIG. 2, in accordance with another non-limiting example;

FIG. 7 is a top view of the RESS with the battery cell support surface removed, in accordance with yet another non-limiting example; and

FIG. 8 is a cross-sectional partial side view of the RESS taken through the line 8-8 of FIG. 7, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

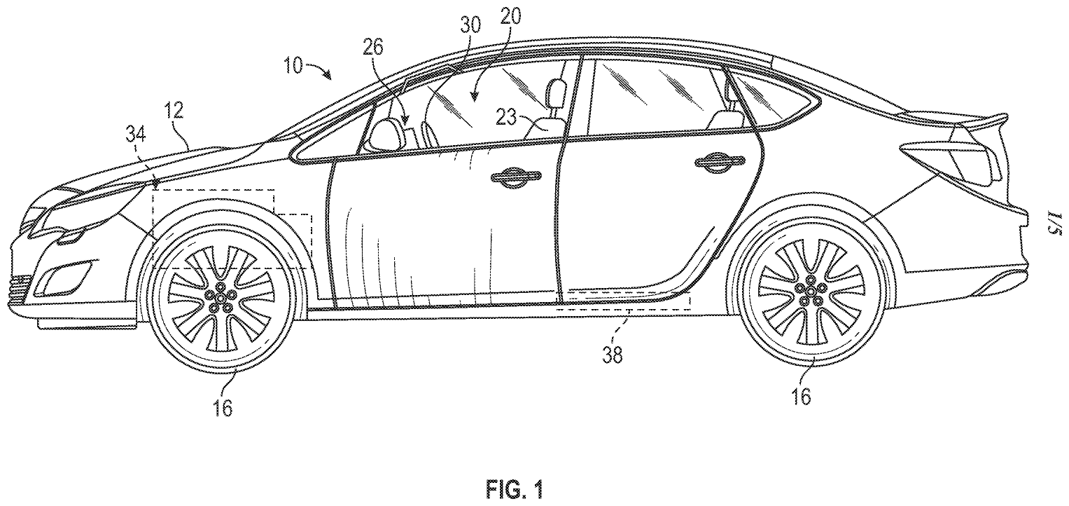

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control the orientation of select ones of the plurality of wheels 16. Vehicle 10 includes an electric drive unit 34 that provides power to one or more of the plurality of wheels 16.

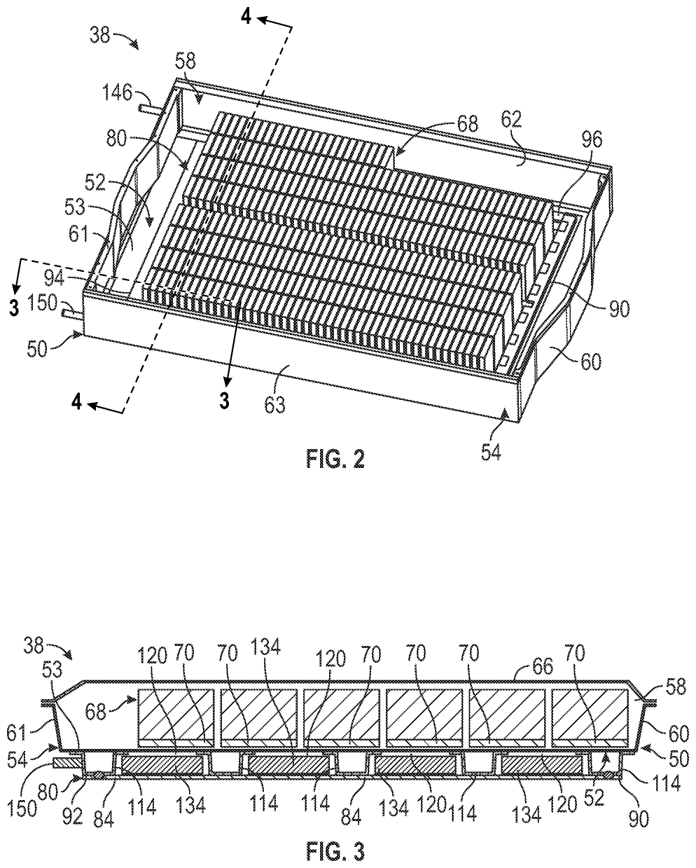

A rechargeable energy storage system (RESS) or battery assembly 38 is arranged in body 12 and provides power to electric drive unit 34. At this point, it should be understood that the location of electric drive unit 34 and battery assembly 38 may vary. As shown in FIG. 2, battery assembly 38 includes a housing 50 having a base wall 52 that defines a battery cell support surface 53, and a plurality of side walls 54 that collectively define an interior zone 58.

In a non-limiting example, the plurality of side walls 54 include a first side wall 60, a second side wall 61, a third side wall 62, and a fourth side wall 63. Housing 50 also includes a cover 66 (FIG. 3). A plurality of battery cells 68 is arranged in interior zone 58 of housing 50. Battery cells 68 rest upon battery cell support surface 52. An interface layer 70 (FIG. 3) may be arranged between the plurality of battery cells 68 and battery cell support surface 52. Interface layer 70 may take the form of a layer of thermal interface material (TIM) or an adhesive material that bonds the plurality of battery cells 68 to battery cell support surface 52.

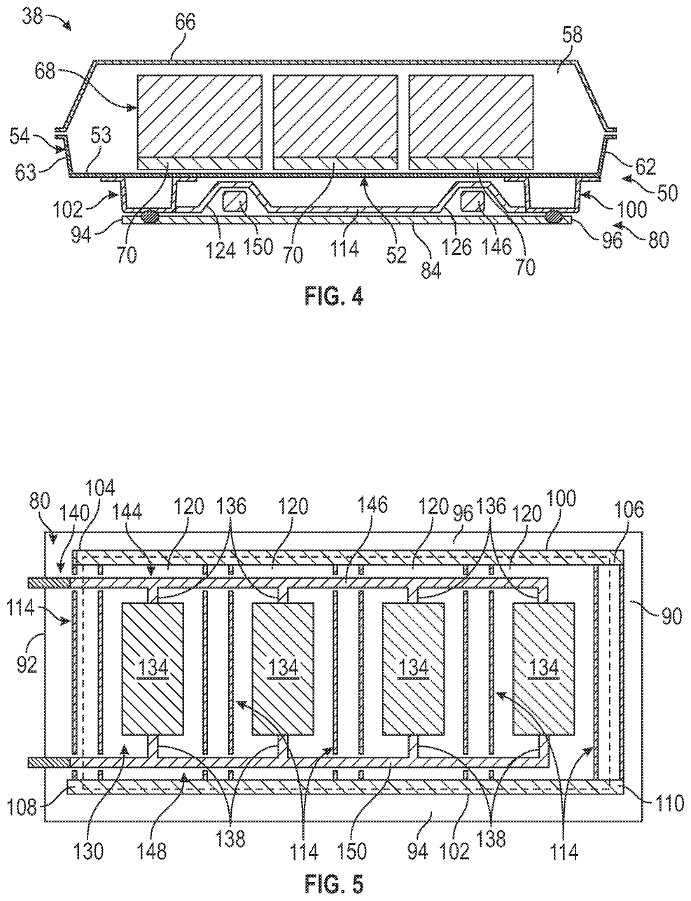

Referring to FIGS. 3 and 4 and with continued reference to FIG. 2, a heat exchange member or cold plate 80 is coupled to housing 50. Heat exchange member 80 includes a bottom plate 84, that may be an external surface (not separately labeled) of vehicle 10. As such, bottom plate 84 is substantially planar. Bottom plate 84 includes a first edge 90, a second edge 92 that is opposite of and substantially parallel to first edge 90. Bottom plate 84 also includes a first side edge 94 and a second side edge 96 that is opposite of and substantially parallel to first side edge 94. First side edge 94 and second side edge 96 extend between and connect with first edge 90 and second edge 92.

In a non-limiting example, a first stiffening member 100 (FIG. 5) extends along second side edge 96 and a second stiffening member 102 extends along first side edge 94. Referring to FIG. 5 and with continued reference to FIGS. 3 and 4, first stiffening member 100 includes a first end 104 and a second end 106 opposite first end 104. Similarly, second stiffening member 102 includes a first end portion 108 and a second end portion 110 opposite first end 104. A plurality of stiffening elements 114 extend between and connect first stiffening member 100 and second stiffening member 102.

In a non-limiting example, one of the plurality of stiffening elements 114 extends between and connects first end 104 of first stiffening member 100 and first end portion 108 of second stiffening member 102. Another of the plurality of stiffening elements 114 extends between and connects second end 106 of first stiffening member 100 and second end portion 110 of second stiffening member 102. The remaining ones of the plurality of stiffening elements 114 are substantially evenly spaced along and between first edge 90 and second edge 92 forming a plurality of channels 120. In a non-limiting example, select ones of the plurality of stiffening elements 114 include a first recess 124 and a second recess 126.

Heat exchange member 80 supports a cooling system 130 in accordance with a non-limiting example. Cooling system 130 includes a plurality of inflatable bladders 134 that receive an amount of cooling fluid. Each of the plurality of inflatable bladders 134 includes a cooling fluid inlet 136 and a cooling fluid outlet 138. In a non-limiting example, cooling fluid enters the cooling fluid inlet 136 and expands each of the plurality of inflatable bladders 134 into a contact with battery cell support surface 52. The contact establishes a heat exchange relationship between the cooling fluid and the plurality of battery cells 68 resting on battery cell support surface 52. In a non-limiting example, each of the plurality of inflatable bladders 134 is arranged in a corresponding one of the plurality of channels 120. At this point it should be understood that while each of the plurality of channels 120 is shown to include a single one of the plurality of inflatable bladders 134, the number of inflatable bladders 134 in each channel 120 may vary depending upon cooling requirements and battery assembly size.

In a non-limiting example, a cooling fluid supply system 140 is connected to the plurality of inflatable bladders 134. Cooling fluid supply system 140 includes an inlet manifold 144 including an inlet conduit 146 connected to the cooling fluid inlet 136 of each of the plurality of inflatable bladders 134. Cooling fluid supply system 140 also includes an outlet manifold 148 including an outlet conduit 150 connected to the cooling fluid outlet 138 of each of the plurality of inflatable bladders 134.

In a non-limiting example, cooling fluid flows from a cooling fluid supply tank (not shown) into inlet manifold 144. The cooling fluid passes through inlet conduit 146 flooding and expanding each of the plurality of inflatable bladders 134. The cooling fluid absorbs heat from the plurality of battery cells 68 and flows to a heat exchanger (also not shown) via outlet manifold 148. The cooling fluid may then be returned to cooling fluid supply tank. At this point, it should be understood that the cooling fluid may be a liquid, a gas, or a multi-phase fluid. Further, it should be understood that valves may be arranged at the cooling fluid inlet 136 and/or the cooling fluid outlet 138 of each of the plurality of inflatable bladders 134 to control cooling fluid movement.

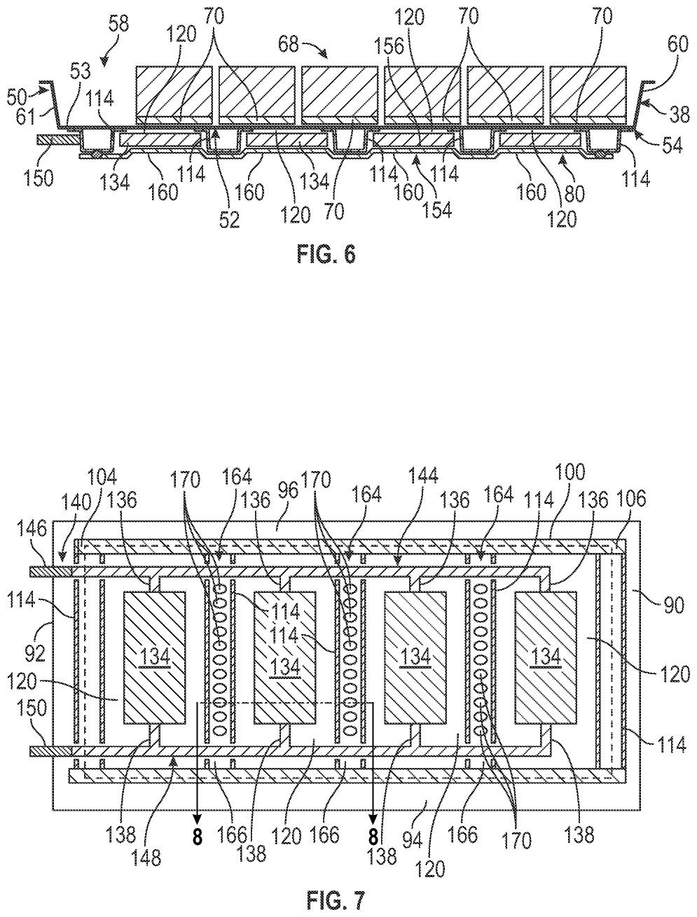

Referring to FIG. 6, heat exchange member 80 may include a bottom plate 154 that includes a non-planar surface 156. Non-planar surface 156 includes a plurality of projections 160 that extend between first edge 90 and second edge 92. The projections 160 extend into each channel 120 toward battery cell support surface 52. The plurality of projections 160 reduce an overall volume of each of the plurality of channels 120 thereby reducing the amount of cooling fluid needed to expand each of the plurality of inflatable bladders 134 to ensure good contact and a positive heat exchange interface.

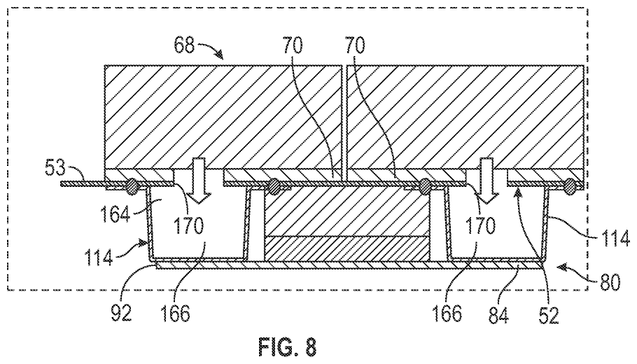

In a non-limiting example, each of the plurality of stiffening elements 114 may also function as a vent gas exhaust conduit 164 shown in FIGS. 7 and 8. That is, each of the plurality of stiffening elements 114 may have a hollow cross-section that defines a vent gas passage 166 fluidically connected to the interior zone 58 via a plurality of vent gas passages or openings 170. Vent gas passages 170 are formed in battery cell support surface 52 and extend into and connect with vent gas exhaust conduit 164 in each of the plurality of stiffening elements 114. Each battery cell 68 includes a vent gas opening (not shown) that is aligned with corresponding ones of the vent gas passages 170. A seal (also not shown) is provided between each battery cell 68 and battery cell support surface 52 at each of the plurality of vent gas passages 170. Heat exchange member 80 may be provided with an air moving device (not shown) that creates a positive pressure in interior zone 58 or a negative pressure in each vent gas exhaust conduit 164 in order to remove gases that may vent from the plurality of battery cells 68 from battery assembly 38.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly comprising:
a housing including a battery cell support surface and a plurality of side walls that collectively define an interior zone;
a plurality of battery cells arranged in the interior zone;
a heat exchange member mounted to the housing, the heat exchange member including a bottom plate; and
a cooling system arranged in the heat exchange member, the cooling system including an inflatable bladder arranged between the battery cell support surface and the bottom plate, the inflatable bladder being selectively inflated with a cooling fluid to be brought into contract with the battery cell support surface.

2. The battery assembly according to claim 1, further comprising a plurality of channels extending between the battery cell support surface and the bottom plate, wherein the inflatable bladder comprises a plurality of inflatable bladders, each of the plurality of inflatable bladders being arranged in a corresponding one of the plurality of channels.

3. The battery assembly according to claim 2, further comprising a cooling fluid supply system including an inlet manifold having an inlet conduit fluidically connected to each of the plurality of inflatable bladders and an outlet manifold having an outlet conduit fluidically connected to each of the plurality of inflatable bladders.

4. The battery assembly according to claim 3, wherein the heat exchange member includes a first edge, a second edge opposite the first edge, a first side edge, and a second side edge opposite the first side edge, a first stiffening member extends along the first edge, and a second stiffening member extends along the second edge, the first stiffening member and the second stiffening member being joined to the battery cell support surface and the bottom plate.

5. The battery assembly according to claim 4, further comprising a plurality of stiffening elements extending between and connected to the first stiffening member and the second stiffening member, each of the plurality of channels being defined by adjacent ones of the plurality of stiffening elements.

6. The battery assembly according to claim 5, wherein select ones of the plurality of stiffening elements include a first recess that is receptive of the inlet conduit and a second recess that is receptive of the outlet conduit.

7. The battery assembly according to claim 5, wherein each of the plurality of stiffening elements includes a vent passage, the battery cell support surface including a plurality of vent gas passages that fluidically connect the interior zone and the vent passage.

8. The battery assembly according to claim 2, wherein the battery cell support surface fluidically isolates the interior zone from the plurality of inflatable bladders.

9. The battery assembly according to claim 2, wherein the bottom plate includes a non-planar surface having a plurality of projections, each of the plurality of projections extending towards corresponding ones of the plurality of channels.

10. The battery assembly according to claim 1, further comprising one of a thermal interface material (TIM) layer and an adhesive layer arranged between the plurality of battery cells and the battery cell support surface.

11. A vehicle comprising:
a body;
a plurality of wheels supporting the body;
an electric drive unit supported in the body; and
a battery assembly operatively connected to the electric drive unit, the battery assembly comprising:
a housing including a battery cell support surface and a plurality of side walls that collectively define an interior zone;
a plurality of battery cells arranged in the interior zone;
a heat exchange member mounted to the housing, the heat exchange member including a bottom plate; and
a cooling system arranged in the heat exchange member, the cooling system including an inflatable bladder arranged between the battery cell support surface and the bottom plate, the inflatable bladder being selectively inflated with a cooling fluid to be brought into contract with the battery cell support surface.

12. The vehicle according to claim 11, further comprising a plurality of channels extending between the battery cell support surface and the bottom plate, wherein the inflatable bladder comprises a plurality of inflatable bladders, each of the plurality of inflatable bladders being arranged in a corresponding one of the plurality of channels.

13. The vehicle according to claim 12, further comprising a cooling fluid supply system including an inlet manifold having an inlet conduit fluidically connected to each of the plurality of inflatable bladders and an outlet manifold having an outlet conduit fluidically connected to each of the plurality of inflatable bladders.

14. The vehicle according to claim 13, wherein the heat exchange member includes a first edge, a second edge opposite the first edge, a first side edge, and a second side edge opposite the first side edge, a first stiffening member extends along the first edge, and a second stiffening member extends along the second edge, the first stiffening member and the second stiffening member being joined to the battery cell support surface and the bottom plate.

15. The vehicle according to claim 14, further comprising a plurality of stiffening elements extending between and connected to the first stiffening member and the second stiffening member, each of the plurality of channels being defined by adjacent ones of the plurality of stiffening elements.

16. The vehicle according to claim 15, wherein select ones of the plurality of stiffening elements include a first recess that is receptive of the inlet conduit and a second recess that is receptive of the outlet conduit.

17. The vehicle according to claim 15, wherein each of the plurality of stiffening elements includes a vent passage, the battery cell support surface including a plurality of vent gas passages that fluidically connect the interior zone and the vent passage.

18. The vehicle according to claim 12, wherein the battery cell support surface fluidically isolates the interior zone from the plurality of inflatable bladders.

19. The vehicle according to claim 18, wherein the bottom plate include a non-planar surface having a plurality of projections, each of the plurality of projections extending towards corresponding ones of the plurality of channels.

20. The vehicle according to claim 11, further comprising one of a thermal interface material (TIM) layer and an adhesive layer arranged between the plurality of battery cells and the battery cell support surface.
